(19) United States
(12) Patent Application Publication
(10) Pub. No.: US 2019/0364919 A1
(43) Pub. Date: Dec. 5, 2019

(54) METHOD OF MANUFACTURING PASTA FILATA CHEESE

(71) Applicant: ALPMA Alpenland Maschinenbau GmbH, Rott am Inn (DE)

(72) Inventors: Josef Hubatschek, Bad Endorf (DE); Alois Seemueller, Bad Aibling (DE); Gisbert Strohn, Amerang (DE)

(21) Appl. No.: 16/391,165

(22) Filed: Apr. 22, 2019

(30) Foreign Application Priority Data
Apr. 24, 2018 (DE) 102018109768.9
Jun. 21, 2018 (DE) 102018114957.3

(51) Int. Cl. A23C 19/024; A23C 19/068; A23C 19/032; A23C 19/05; A01J 25/00

(52) U.S. Cl. CPC A23C 19/0245; A23C 19/0684; A23C 19/0326; A01J 25/08; A01J 25/001; A01J 25/002; A01J 25/008; A23C 19/051

(57) ABSTRACT

Disclosed is a method for the manufacturing of pasta filata cheese, wherein skim milk is first supplied to a transport system having a plurality of separate transport containers, wherein curd is produced from the skim milk in the region of a first process section of the transport system, by the addition of acidification cultures; wherein the curd produced is coagulated in the region of a second process section, wherein the coagulated curd is exposed to an acidification process for an acidification period in the region of a third process section; and wherein the acidified curd is removed from the transport system in an outgoing section at the end of the acidification period and is supplied to a subsequent process step in which the acidified curd is divided into portions. The curd remains in the transport system up to the removal of the curd after the end of the acidification process.

The present invention relates to a method of manufacturing, in particular of continuously manufacturing, pasta filata cheese.

In the manufacture of pasta filata cheese, an end product, for example mozzarella, is produced from skim milk as the starting product, with known processes being divided into a plurality of method steps. The different method steps are conventionally run through in separate plant systems that are isolated from one another and that can by all means have a certain diversity. In accordance with the sequence of the method steps, an intermediate product of the pasta filata cheese manufacture, that is the curd, is in this process transferred from one of the separate plant systems into a next one. The methods in particular require that the intermediate product of the pasta filata cheese manufacture rests for a specific time period, the so-called acidification time, before the further processing in which the pH of the intermediate product falls to a value in a desired range. This method step of so-called “curd acidification” or “curd maturation” conventionally takes place in a separate plant system that can be of a very complex and expensive design. The transfer of the intermediate product into said plant system furthermore interrupts the sequence of the process, which is problematic with respect to its efficiency and to a production quantity of pasta filata cheese achievable by the processes.

It is therefore the object of the invention to provide a method of manufacturing pasta filata cheese that can be performed more simply and less expensively and that permits a continuous and efficient manufacture of pasta filata cheese.

The object is satisfied by a method in accordance with claim 1. Skim milk is here first supplied in an incoming section to a transport system having a plurality of separate transport containers, in particular basins. Curd is produced from the skim milk in the region of a first process section of the transport system, in particular by adding rennet or acidification cultures. The curd produced is coagulated in the region of a second process section of the transport system, in particular by cutting, stirring and/or heating. The coagulate curd is subsequently subjected to an acidification process for an acidification period in the region of a third process section of the transport system. At the end of the acidification period, the acidified curd is removed from the transport system in an outgoing section of the transport system and is supplied to a subsequent process step in which the acidified curd is in particular divided into portions and/or is cut into strips . The curd remains in the transport system during the process outlined above, i.e. from the incoming section up to the removal of the curd after the end of the acidification period.

The method is thus based on a transport system that supplies the separate transport containers one after the other to all the required process sections for manufacturing pasta filata cheese. All the steps required can accordingly be carried out with and/or within one and the same technical plant, with the third process section, the so-called curd maturation, directly following the first and second process sections, the so-called curd preparation, without a system change. The method is hereby substantially simplified and optimized, on the one hand, and the concept of a technical process plant for the manufacture of pasta filata cheese is simplified and the effort and/or cost for the setting up and operating such a plant is also reduced, on the other hand.

The transport containers can be configured as basins and/or can be produced from metal or plastic, with a plastic production being preferred. The capacity of the transport containers can, for example, be in the range of 100 liters to 1000 liters, with the transport containers in particular being able to be shaped uniformly and in particular being able to have the same dimensions and/or the same capacity. It is, however, also conceivable that the transport containers differ in their dimensions and/or capacities.

A comparatively compact design of the transport containers is accompanied by the advantage that the contents can be monitored and inspected better during the different process sections. The time period that the curd, for example, requires to reduce its pH to a desired value during the curd maturation is not constant, but can depend on factors such as the composition of the supplied skim milk, the temperature, or the activity of an introduced acidification culture. It can therefore be necessary to adapt the period of the curd maturation accordingly and to change it using monitored parameters. It can also be sensible that the temperature of the curd is directly changed during the curd preparation, for example directly by heating the curd within the transport container, but also indirectly via a temperature control of a wall of the transport containers or via a control of the environmental temperature of the transport containers.

The method enables a continuous process sequence, with the individual transport containers being supplied one after the other to the individual process sections in a recipe-controlled and reproducible manner by a continuous and/or clocked feed of the transport system. It is understood that the transport system is controlled by a suitable control device that preferably also enables a requirement-based adaptation of the feed. This can also automatically take place on the basis of state parameters of the system and/or of the conveyed product in the transport containers. The state parameters can be determined by suitable sensors.

Preferred embodiments of the invention can be seen from the dependent claims and from the description.

In accordance with an embodiment, the transport system is designed as free of interruption between the incoming section and the outgoing section. The method thus runs through an uninterrupted process that starts with the supply of skim milk from which acidified curd is produced over different process sections and that ends with the removal of the produced curd. The transport system is for this purpose configured such that it guides the transport containers through the entire process and supplies them to the corresponding process sections.

In accordance with a further embodiment, the transport containers are moved in a clocked and/or continuous manner between the sections and/or in the region of the sections. The transport system is for this purpose configured to transport the transport containers at a speed matched to the respective process section. Provision can, for example, be made that the transport system does not move the transport containers or only moves them comparatively slowly during the acidification or the curd maturation. The feed speed—whether clocked or continuous—of the basins thus does not necessarily have to be constant during the total process, but can rather by all means vary.

The transport containers are preferably supplied to a cleaning system in which the transport containers are cleaned after the removal of the curd. The cleaning by means of the cleaning system can be provided as a separate unit or can be integrated into the transport system as an additional process section that follows the outgoing section. It is conceivable here that the transport containers are first cleaned in a cleaning section and are then supplied to the incoming section again by means of the transport system. The transport system can even form a substantially closed circuit.

In accordance with an even further embodiment, at least some of the liquid components (whey) of the contents of the transport containers is separated after the coagulation of the curd and before the acidification process, with the separated liquid components in particular being removed from the transport containers. Depending on the desired process management or cheese recipe, it is possible by this additional process section to drain a definable portion of the liquid components from the transport containers in the transition from the curd preparation to the acidification process without interrupting the method in accordance with the invention. This process section can be repeated at any point within the process section of the curd preparation depending on the specification or on the requirement. The liquid components can here, for example, be removed by sucking off or by skimming off. A solid-liquid phase separation can also take place mechanically, for example by means of a screen or a grating.

At least some of the liquid components of the contents of two or more transport containers is preferably combined, in particular in a transport container of the transport system, in accordance with requirements after the separation. In this respect, it can be an initially empty transport container that is newly provided by the transport system. It is, however, also conceivable that the contents of the transport containers are combined in one of the transport containers already partly filled with curd. Emptied containers are then removed. The number of transport containers required in the process can be reduced or minimized by the combination without decreasing the production rate of produced pasta filata cheese, i.e. the quantity of the curd removable per unit of time at the outgoing section. The smaller number of required transport containers enables a design of the transport system that is as space-saving as possible and that is simpler from a technical plant aspect, whereby the process can be carried out inexpensively.

In accordance with an embodiment, transport containers that were emptied as part of the joining of the contents of two or more transport containers are supplied to a cleaning system. The emptied containers, that are thus no longer needed in the further process, can here remain in the transport system and can be supplied to the cleaning process section. If a cleaning system is provided that is separate from the transport system, the emptied transport containers can be removed from the transport system and then supplied to the separate cleaning system. In both cases, the cleaned transport containers can be available to the transport system again at the incoming section subsequent to the cleaning to run through a further cycle of the process.

The acidification or maturation of the curd can take place under whey. It is, however, also possible to provide a drainage of the whey. For this purpose, the curd produced—before or after the coagulation of the curd in the region of the second process section—can be transferred into at least one drainage section, in particular a drainage basket, respectively arranged in the transport containers to drain off whey separating from the curd. The curd preferably remains in the drainage section up to the end of the acidification process. An earlier removal is also conceivable, however.

The whey separating from the curd is in particular removed from the drainage section. This can be done actively (e.g. by suction). A passive removal of the whey is, however, preferred. The drainage section is, for example, a basket-like structure that has perforations. Whey separating from the curd can exit through the perforations, for example can drip downward. The separating whey can be collected in a collection section of the respective transport container, for example in the region of a bottom section of a transport basin. The collected whey can be supplied to a further processing.

A second aspect of the invention relates to an apparatus for manufacturing, in particular for continuously manufacturing, pasta filata cheese in accordance with a method in accordance with the invention comprising a transport system having a plurality of separate transport containers, in particular basins, wherein the transport system is designed as free of interruption between an incoming section in which skim milk can be received by the transport containers and an outgoing section in which acidified curd can be removed from the transport containers at the end of an acidification period.

The transport system can, for example, be configured such that rail-like transport systems are defined by means of which the transport containers are supplied to the corresponding process sections. It is, for example, conceivable here that the transport containers have wheels that are supported on the rail-like transport paths and that make it possible to transport the transport containers from one section to the next. In a further embodiment, the transport containers can, for example, be supported in a manner suspended at rollers that are held in the rail-like paths and that permit a movement of the transport containers along the rail-like transport paths. Depending on the respective demand profile present, however, different embodiments of the transport system—e.g. with respect to the drive of the system and/or with respect to the guiding of the containers—and of the associated transport containers are also conceivable.

The transport of the transport containers in the transport system can take place manually, semiautomatically, or fully automatically. The transport system is preferably connected to a control device that controls the supply of the transport containers to the corresponding process sections, i.e. that in particular adapts and/or varies the speed of the transport containers in the transport system in dependence on predefined parameters and/or on state parameters of the system and/or of the content of the transport containers in the corresponding process sections. The transport system can be operated in a clocked operation or continuously. A combination of a clocked feed (e.g. on the filling of the containers) and a continuous feed of the containers (e.g. during acidification) is also conceivable. The control device can be a component of a higher ranking plant control that monitors and/or controls all the steps of the method and of plant parts connected upstream or downstream or associated therewith or can at least be connected thereto. The control device can, however, naturally also be configured as a separate device without a connection to a higher ranking plant control.

In accordance with an embodiment, the apparatus further comprises an apparatus that is configured for coagulating curd produced from the skim milk in the transport containers, in particular by cutting, stirring and/or heating. The milk protein of the skim milk coagulated by the addition of rennet or acidification cultures is here solidified to form a fixed agglomerate, so-called curd grain. The apparatus can have different kinds of shapes that are configured to comminute the contents of the transport containers. After the coagulation of the curd, the so-called curd preparation, the predominant filling volume of the transport container comprises liquid components, so-called free whey, in which the solid components, i.e. the coagulated curd, are supported. The liquid and the solid phases are here typically present in a ratio of 9 to 1, i.e. approximately 90% of the filling volume of the transport containers comprises free whey.

To remove the liquid components not required from the process, the apparatus can preferably further comprise an apparatus that is configured to separate at least some of the liquid components of the contents of the transport containers. The apparatus can be configured here such that the liquid components can be removed from the transport containers, for example by a suitable suction or skimming of the liquid components. It is also conceivable that the solid components are removed from the transport containers, for example by means of a grating-like or screen-like apparatus, and are transferred into different transport containers. However, the curd here ultimately remains in the transport system. The transport containers having the remaining liquid components can be emptied in this case and the free whey can be further processed to whey products, for example.

The apparatus further preferably comprises an apparatus that is configured to combine the contents of two or more transport containers in one transport container after the separation of at least some of the liquid components. Due to the large volume reduction of the contents of the transport containers to be processed after the separation of the liquid components has taken place, the possibility thus arises of reducing the number of required transport containers in the transport system without decreasing the production rate of the pasta filata cheese produced. The transport system can thus be configured as space-saving and the technical plant effort of the apparatus can be reduced by the smaller number of required transport containers, whereby the apparatus can be manufactured and operated less expensively.

In accordance with an embodiment, the apparatus further comprises a cleaning apparatus for cleaning the transport containers. The cleaning apparatus can be provided as a separate unit or can be integrated into the transport system. It is conceivable here that the transport containers are cleaned by the cleaning apparatus and are then supplied back to the incoming section by means of the transport system, which generally enables a configuration in which the transport containers are moved in a substantially closed circuit in the transport system. A shape of the transport containers that is as simple as possible provides the advantage that the cleaning system can be implemented inexpensively and that the cleaning can be performed fast and in a simple manner.

In accordance with a further embodiment, at least some of the transport containers have a respective drainage section, in particular with the drainage section comprising at least one element placeable into the respective transport container at times by which the curd can be received for the separation of whey. The insertable element is, for example, a basket-like structure in which the curd is placed. The insertable element can be designed at least sectionally in the manner of a basket or of a screen and/or can have perforations through which the whey separating from the curd can flow out. Alternative embodiments of the drainage section or of the insertable element are conceivable. For example, a separating base can also be provided that is inserted into one of the transport containers to separate the drainage section from a collection section for the reception of the separating whey.

The invention will be described in the following purely by way of example with reference to advantageous embodiments and to the enclosed drawing. There are shown, schematically in each case,

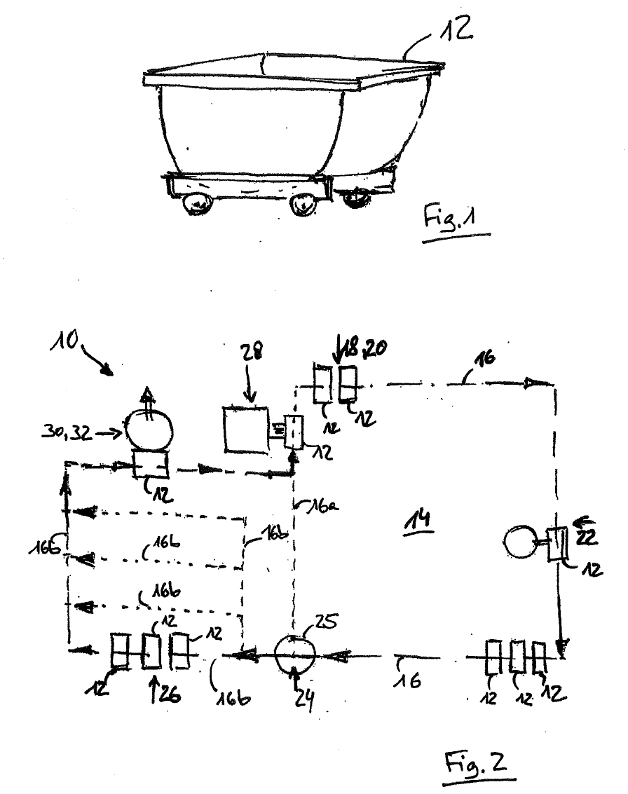

FIG. 1 an embodiment of a transport container of an apparatus in accordance with the invention for carrying out a method in accordance with the invention for manufacturing pasta filata cheese;

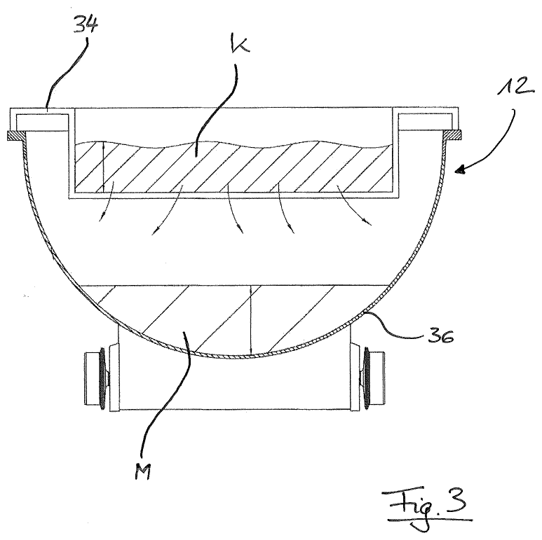

FIG. 2 an embodiment of an apparatus in accordance with the invention for carrying out a method in accordance with the invention for manufacturing pasta filata cheese; and

FIG. 3 a further embodiment of a transport container with an inserted drainage section.

FIG. 1 shows the view of a transport container 12 of an apparatus in accordance with the invention for carrying out a method in accordance with the invention for manufacturing pasta filata cheese. In this embodiment, the transport container is configured as a basin 12 that can be produced from plastic, for example. The basin 12 comprises an upwardly open tub at whose lower ends rollers are attached by means of which the basin 12 can be moved along rail-like transport paths 16 (see FIG. 2). The capacity of the basin 12 is here typically between 100 and 1000 liters.

FIG. 2 shows an embodiment of an apparatus 10 in accordance with the invention for carrying out a method in accordance with the invention for manufacturing pasta filata cheese. The apparatus 10 comprises a transport system 14 that supplies the basins 12 to different process sections one after the other by a continuous feed. The transport system 14 comprises a plurality of basins 12 that are substantially the same in this embodiment and that are moved along transport paths 16 in a clocked and/or continuous manner. The transport system 14 can for this purpose, for example, have a sprocket drive or chain drive (neither shown) that is connected to the basins 12 (releasably as required) and can thus effect the feed. Other drive systems can also be used.

The transport system 14 is controlled by a higher ranking control device (not shown) that controls the clocking and/or the speed of the feed of the transport containers in accordance with the demands of the respective process sections.

The apparatus 10 with the transport system 14 is configured as a closed circuit in which major process steps are carried out that are necessary for the manufacture of pasta filata cheese. For this purpose, the basins 12 are first supplied to an incoming section 18 and are then transported by the transport system 14 to and through all the process sections 20, 22, 24, 26 before they are emptied at an outgoing section 30. The basins 12 are subsequently supplied to the incoming section 18 again.

Skim milk is supplied to the basins 12 one after the other at the incoming section 18, e.g. by means of lines, not shown. If a basin 12 is filled with skim milk, the basin 12 is pushed along the transport path 16 by the transport system 14 by a distance that substantially corresponds to at least a length of the basin 12—viewed in the transport direction. At the same time, an empty basin 12 is supplied to the incoming section 18 by the transport system 14 to also fill it with skim milk.

In the region of the incoming section 18, or after it, acidification cultures and/or rennet is added to the skim milk in the basins 12 in a first process section 20 to stimulate the production of curd in the basins 12.

A basin 12 having a content of 1000 liters is filled in 80 seconds, for example, corresponding to a filling rate of the apparatus 10 of 45 basins per hour. The supplied quantity of 45,000 liters of skim milk per hour here corresponds to a manufacturing quantity of 5000 kg pasta filata cheese per hour. Other process parameters (e.g. quantities of milk or cheese, filling rates, capacities, and number of basins, . . . ) are, however, also easily conceivable.

As many basins 12 as desired can be filled one after the other with skim milk by this clocked feed, with a limitation only being given by the space available for the apparatus 10 in a production hall. Different kinds of shapes of the transport paths 16 are conceivable here, for example rectangular as in the described embodiment, but also serpentine, whereby a particularly compact design of the apparatus 10 or of the transport system 14 can be achieved.

Starting from the incoming section 18 or from the first process section 20, the basins 12 are supplied to a second process section 22 in which the curd produced in the basins 12 is coagulated. This can in particular take place by cutting, stirring and/or heating, with corresponding apparatus such as stirrers, heating units, etc. being provided in the second process section 22. The feed of the basins 12 in the second process section 22 takes place with a clock rate adapted to the coagulation process and/or at a (more or less) continuous feed speed.

After the second process section 22, the coagulation of the curd, approximately 90% of the volume in the basin 12 is present in liquid form as free whey. To separate a large part of this free whey from the best components of a basin filling, the basins 12 are supplied to a third process section 24. The free whey is there removed to a larger part by suction from the basins 12, with care being taken that the curd remains in the basin 12 i.e. is held back by suitable means such as screens. The separated whey, unlike the curd, is removed from the transport system and thus from the manufacturing process and can be supplied to a further processing.

After the separation of at least the larger part of the free whey, the curd of two or more basins 12 is combined in one basin 12, with the contents of basins 12, for example, being able to be combined in one basin 12 by means of a lifting and tiling apparatus 25. The emptied basins 12 are supplied to a cleaning process of a fifth process section 28 over a transport path 16a of the transport system 14.

While the first, second, and third process sections 20, 22, 24 can be subsumed under the term curd preparation, the fourth process section 26 serves for the curd maturation (acidification) in which the pH of the curd is continuously lowered until it reaches a range desired for pasta filata cheese. In this fourth process section 26, the curd remains in the basins 12 for approximately 120 to 150 minutes, with the time duration or the dwell time or reaction time being influenced by factors such as the acidification cultures used, the properties of the skim milk, the temperature, and similar. A monitoring of the pH can therefore be provided to correspondingly decrease or increase the dwell time or to able to adapt other parameters.

In the fourth process section 26, the basins 12 rest within the transport system 14 or are moved by the transport system 14 along a transport path 16b at a comparatively low speed (clocked or continuous). This path 16b effects a buffering of the basins 12 to provide sufficient time for the acidification of the curd. In the example shown, it includes parallel branches that are joined together again, which has proved to be space-saving. A buffering of the basins 12 can also be provided at other points of the path 16 as required.

Provision can additionally be made that the fourth process section 28 has an apparatus for stirring the curd in the basins 12 at one or more points to keep the curd directly in movement and to achieve a sufficient mixing of the curd in the basins 12.

After the end of the curd maturation in the fourth process section 26, the basins 12 are supplied by the transport system 14 to the outgoing section 30 where the acidified curd is removed from the basins 12 to be divided into portions and/or cut into strips in a sixth process section 32—directly following in the present embodiment.

The emptied basins 12 are supplied to the fifth process section 28 where the basins 12 are cleaned by the cleaning system. The cleaning of the emptied basins 12 is integrated in the transport system in the present embodiment, i.e. the cleaning takes place during ongoing operation of the apparatus 10. An interruption of the production to clean the basins 12 is therefore not necessary.

After cleaning has taken place, the basins 12 are again supplied to the incoming section 18 over the transport system 14 to be able to receive skim milk in a new production cycle.

The skim milk or the curd produced therefrom thus remains in the system 14, in particular also during the curd maturation, between the sections 18 and 30. An optimized process management is ensured by the method in accordance with the invention and by the apparatus in accordance with the invention that represents a continuous tracking of the process sections in a similar sequence having similar devices and tools and that increases the consistency and reproducibility of the manufacturing process.

As was initially explained, the curd produced—marked by reference symbol K in FIG. 3—can be arranged at times, preferably up to the end of the curd maturation, in a drainage section of the basins 12 to be able to drain off whey separating from the curd. In the embodiment in accordance with FIG. 3, the drainage portion is a basket 34 that can be inserted into one of the basins 12. The basket 34 has perforations in at least a bottom section and the whey separating from the curd can exit downwardly from the basket 34 through them. The separating and downwardly dripping whey (shown schematically as arrows) is collected in a collection region 36 in the bottom region of the basin 12. The collected whey—marked by reference symbol M in FIG. 3—can be supplied to a further processing.

To remove the curd, in particular also after the end of the curd maturation, the basket 34 is removed and/or the basin 12 is tilted with the basket 34 that in this case is preferably (releasably) fastened to the basin 12. The basket 34 can subsequently be cleaned, optionally together with the basin 12 or separately.

### REFERENCE NUMERAL LIST

10 apparatus for manufacturing pasta filata cheese

12 basin

14 transport system

16 transport path

16a transport path

16b transport path

18 incoming section

20 first process section

22 second process section

24 third process section

25 lifting and tilting apparatus

26 fourth process section

28 fifth process section

30 outgoing section

32 sixth process section

34 drainage basket

36 collection region

K curd

M whey

1.-16. (canceled)

17. A method of manufacturing pasta filata cheese, wherein
skim milk is first supplied to a transport system having a plurality of separate transport containers in an incoming section;
curd is produced from the skim milk in the region of a first process section of the transport system;
the curd produced is coagulated in the region of a second process section of the transport system;
the coagulated curd is exposed to an acidification process for an acidification period in the region of a third process section of the transport system; and
the acidified curd is removed from the transport system at the end of the acidification period in an outgoing section of the transport system and is supplied to a subsequent process step,
wherein the curd remains in the transport system up to the removal of the curd after the end of the acidification process.

18. The method in accordance with claim 17, wherein the transport system is designed as free of interruption between the incoming section and the outgoing section.

19. The method in accordance with claim 17, wherein the transport containers are moved in a clocked and/or continuous manner between the sections and/or in the region of the sections.

20. The method in accordance with claim 17, wherein the transport containers are supplied to a cleaning system in which the transport containers are cleaned after the removal of the curd.

21. The method in accordance with claim 17, wherein at least some of the liquid components of the contents of the transport containers are separated after the coagulation of the curd and before the acidification process.

22. The method in accordance with claim 21, wherein the separated liquid components is removed from the transport containers.

23. The method in accordance with claim 21, wherein the contents of two or more transport containers are combined in accordance with requirements after the separation of at least some of the liquid components.

24. The method in accordance with claim 23, wherein the contents of two or more transport containers are combined in a transport container of the transport system.

25. The method in accordance with claim 23, wherein transport containers that were emptied as part of the combining of the contents of two or more transport containers are removed from the transport system and are supplied to a cleaning system.

26. The method in accordance with claim 17, wherein the curd produced is transferred—before or after the coagulation of the curd in the region of the second process section—into at least one drainage section respectively arranged in the transport containers to drain whey separating from the curd.

27. The method in accordance with claim 26, wherein the curd remains in the drainage section up to the conclusion of the acidification process in the region of the third process section.

28. The method in accordance with claim 26, wherein whey separating from the curd is actively or passively removed from the drainage section.

29. The method in accordance with claim 28, wherein the separating whey is collected in a collection section of the respective transport container.

30. An apparatus for manufacturing pasta filata cheese, the apparatus comprising a transport system having a plurality of separate transport containers; and wherein the transport system is designed as free of interruption between an incoming section in which skim milk can be received by the transport containers and an outgoing section in which an acidified curd can be removed from the transport containers at the end of an acidification period, in which method
said skim milk is first supplied to the incoming section;
said curd is produced from the skim milk in the region of a first process section of the transport system;
the curd produced is coagulated in the region of a second process section of the transport system;
the coagulated curd is exposed to an acidification process for the acidification period in the region of a third process section of the transport system; and
the acidified curd is removed and is supplied to a subsequent process step,
with the curd remaining in the transport system up to the removal of the curd after the end of the acidification process.

31. The apparatus in accordance with claim 30, further comprising an apparatus that is configured for coagulating curd produced from the skim milk in the transport containers.

32. The apparatus in accordance with claim 30, further comprising an apparatus that is configured for separating at least some of the liquid components of the contents of the transport container.

33. The apparatus in accordance with claim 32, further comprising an apparatus that is configured to combine the contents of two or more transport containers in one transport container after the separation of at least some of the liquid components.

34. The apparatus in accordance with claim 30, further comprising a cleaning apparatus for cleaning the transport containers.

35. The apparatus in accordance with claim 30, wherein at least some of the transport containers each have at least one drainage section.

36. The apparatus in accordance with claim 35, wherein the drainage section comprises at least one element that is insertable into the respective transport container at times, by which drainage section curd can be received for separating whey.
